(19) United States
(12) Patent Application Publication
(10) Pub. No.: US 2026/0249910 A1
(43) Pub. Date: Aug. 27, 2026

(54) STEERING CONTROL DEVICE, METHOD, AND RECORDING MEDIUM

(71) Applicant: HL MANDO CORPORATION, Pyeongtaek-si (KR)

(72) Inventor: Junho SHIN, Pyeongtaek-si (KR)

(73) Assignee: HL MANDO CORPORATION, Pyeongtaek-si (KR)

(21) Appl. No.: 19/548,255

(22) Filed: Feb. 24, 2026

(30) Foreign Application Priority Data
Feb. 25, 2025 (KR) 10-2025-0024652
Mar. 13, 2025 (KR) 10-2025-0032889
Jan. 16, 2026 (KR) 10-2026-0009271

(51) Int. Cl. B62D 15/02; B62D 6/00

(52) U.S. Cl. CPC B62D 15/025; B62D 6/00

(57) ABSTRACT

A steering control device includes at least one memory storing computer program instructions and at least one processor configured to execute the computer program instructions. The processor generates steering type information of a driver based on driving data of a vehicle using a steering type classification model, extracts steering pattern information from the driving data using a pattern extraction model, and generates a steering profile for each driver based on the steering type information and the steering pattern information. The processor generates steering control information generated based on the steering profile and a steering input of the driver, and controls a steering device according to the steering control information.

### CROSS REFERENCE TO RELATED APPLICATION

This application claims the priority of Korean Patent Application Nos. 10-2025-0024652 filed on Feb. 25, 2025, 10-2025-0032889 filed on Mar. 13, 2025, and 10-2026-0009271 filed on Jan. 16, 2026, respectively, in the Korean Intellectual Property Office, the disclosure of which is incorporated herein by reference in their entireties.

### BACKGROUND

### Technical Field

The present disclosure relates to a steering control device, method and recording medium, and more particularly, to a steering control device, method and recording medium that provide steering response tailored to a driver and driving conditions.

### Description of the Related Art

Generally, a steering device refers to a device that changes a traveling direction of a vehicle by manipulating a rotation direction of a wheel. In particular, recently, an electric steering device that performs steering by generating an electric signal corresponding to a steering input using an electric motor is widely used.

Further, regarding a specific steering input, at what speed and by how much the traveling direction of the vehicle changes, and to what extent feedback should be provided to a driver, should not be determined uniformly, but may vary depending on the driver or driving conditions.

### BRIEF SUMMARY

Various embodiments of the present disclosure provide control of a steering device such that the steering response is appropriately adjusted based on a combined consideration of a driver driving style, a vehicle state, and a driving situation.

Specifically the present disclosure aims to provide a steering control device, a method, and a recording medium capable of performing steering control such that steering output and feedback in a steering device are performed in accordance with a driver and driving conditions.

In one aspect, embodiments of the present disclosure may provide a steering control device comprising: at least one memory comprising computer program instructions, and at least one processor configured to execute the computer program instructions, wherein the at least one processor is configured to: generate steering type information of a driver based on driving data of a vehicle using a steering type classification model, extract steering pattern information of the driver from the driving data using a pattern extraction model, generate a steering profile for the driver based on the steering type information and the steering pattern information, generate steering control information based on the steering profile of the driver and a steering input of the driver, and control a steering device according to the steering control information .

In another aspect, embodiments of the present disclosure may provide a steering control method comprising: generating steering type information of a driver based on driving data of a vehicle using a steering type classification model, extracting steering pattern information of the driver from the driving data using a pattern extraction model, and generating a steering profile for the driver based on the steering type information and the steering pattern information, generating steering control information based on the steering profile of the driver and a steering input of the driver, and controlling a steering device according to the steering control information.

In another aspect, embodiments of the present disclosure may provide a non-transitory computer-readable recording medium having recorded thereon a program for executing a steering control method, the method comprising: generating steering type information of a driver based on driving data of a vehicle using a steering type classification model; extracting steering pattern information of the driver from the driving data using a pattern extraction model; generating a steering profile for the driver based on the steering type information and the steering pattern information; generating steering control information based on the steering profile of the driver and a steering input of the driver; and controlling a steering device according to the steering control information.

According to the present disclosure, it is possible to provide a steering control device, a method, and a recording medium capable of performing steering control such that steering output and feedback in a steering device are performed in accordance with a driver and driving conditions.

### BRIEF DESCRIPTION OF THE SEVERAL VIEWS OF THE DRAWINGS

FIG. 1 is a diagram for exemplarily describing a configuration regarding a steering device that may be used in the present disclosure.

FIG. 2 is a block diagram of an exemplary computing system that may be used in the present disclosure.

FIG. 3 is a block diagram regarding another exemplary configuration of a computing system that may be used in the present disclosure.

FIG. 4 is a flowchart regarding a steering control method according to an embodiment.

FIG. 5 is a flowchart regarding a steering control method according to another embodiment.

FIG. 6 is a flowchart for exemplarily describing correcting control information according to an embodiment.

FIG. 7 is a flowchart for exemplarily describing correcting steering control information according to another embodiment.

FIG. 8 is a flowchart regarding a steering control method according to yet another embodiment.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element "is connected or coupled to", “contacts or overlaps” etc. a second element, it should be interpreted that, not only can the first element “be directly connected or coupled to” or “directly contact or overlap” the second element, but a third element can also be "interposed" between the first and second elements, or the first and second elements can "be connected or coupled to", “contact or overlap”, etc. each other via a fourth element. Here, the second element may be included in at least one of two or more elements that "are connected or coupled to", “contact or overlap”, etc. each other.

When time relative terms, such as "after," "subsequent to," "next," "before," and the like, are used to describe processes or operations of elements or configurations, or flows or steps in operating, processing, manufacturing methods, these terms may be used to describe non-consecutive or non-sequential processes or operations unless the term "directly" or "immediately" is used together.

In addition, when any dimensions, relative sizes etc. are mentioned, it should be considered that numerical values for an element or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

The present disclosure describes a steering control system that generates a personalized steering model for each driver rather than applying fixed assist curves. Using vehicle driving data, the system classifies a driver steering type through clustering and classification, extracts time series steering behavior patterns, and combines them into a driver specific steering profile containing parameters such as steering sensitivity, feedback torque, and restoring force. Real time steering output is then produced from the driver profile together with current driving conditions, thereby forming a driver specific steering response function.

The steering control system further performs steering intent analysis by comparing a current steering input with learned patterns and vehicle and environment states to determine whether the action represents normal operation, risk avoidance behavior, or a driver mistake. Steering control is corrected when beneficial, based on both inferred intent and physical conditions such as vehicle speed or road friction, enabling behavior aware safety intervention rather than purely dynamics based stability control.

The steering profile is continuously updated and may be stored locally or in a cloud system so that steering characteristics follow the driver across sessions or vehicles. Overall, the system provides a human adaptive control approach that learns driver preferences, anticipates risk situations, and adjusts steering behavior to improve safety and driving comfort.

The detailed description of the subject matter will be described with reference to the accompanying drawings.

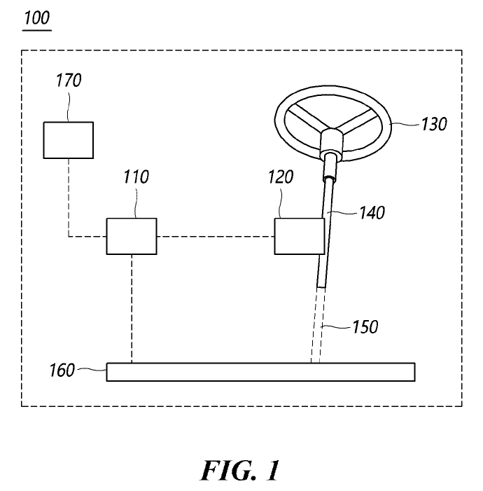

FIG. 1 is a diagram for exemplarily describing a configuration regarding a steering device that may be used in the present disclosure.

Referring to FIG. 1, a steering device 100 may include a steering control device 110, a steering motor 120, a steering wheel 130, an upper shaft 140, a lower shaft 150, and a rack device 160. In this case, the steering control device 110 may transmit and receive data to and from a sensor 170.

As an example, the steering device 100 may include a configuration that performs a steering operation using an electric motor. For example, the steering device 100 may include an Electric Power Steering (EPS) device that generates assist torque for assisting steering force generated by a steering input using an electric motor. As another example, the steering device 100 may include a Steer-by-Wire (SbW) device in which an upper unit and a lower unit are mechanically separated, and a steering input of the upper unit is transmitted using an electric signal.

The steering control device 110 may include a configuration for controlling the steering device 100. For example, the steering control device 110 may include a configuration for controlling the steering device 100 using an Electronic Control Unit (ECU).

As an example, the steering control device 110 may control an electric motor mounted on the steering device 100. In this case, a method of controlling the steering device 100 by the steering control device 110 may vary depending on a position where the electric motor is mounted.

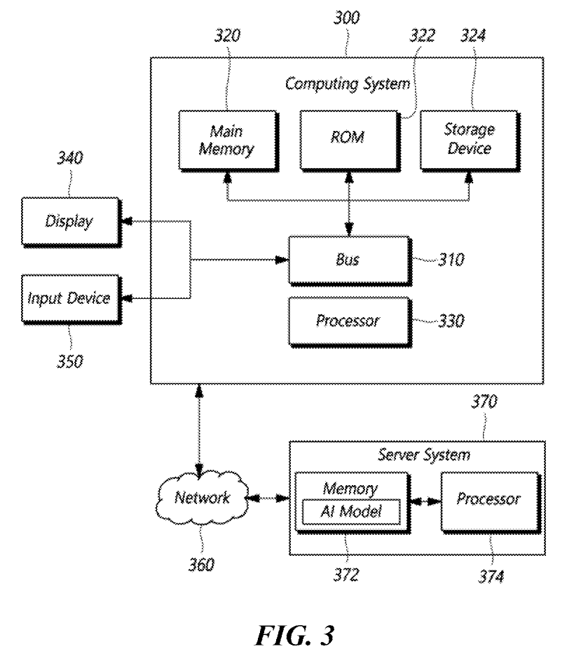

A specific configuration of such a steering control device 110 will be described in more detail in a portion describing the steering control device in FIG. 3 below.

The steering motor 120 may convert input energy into mechanical motion and output it. For example, the steering motor 120 may include a configuration that receives electric energy, converts it into rotational motion, and outputs it. In addition, the steering motor 120 may be electrically connected to the steering control device 110 and become a control target thereof.

For example, if the steering motor 120 is mounted on an upper unit of the steering device 100, the steering control device 110 controls the steering motor 120 so that force generated from the steering motor 120 is transmitted to the upper shaft 140 and the steering wheel 130, thereby controlling rotational motion of the upper shaft 140 and the steering wheel 130.

As another example, if the steering motor 120 is mounted on a lower unit of the steering device 100, the steering control device 110 controls the steering motor 120 so that force generated from the steering motor 120 is transmitted to the lower shaft 150 and the rack device 160, thereby controlling rotational motion of the lower shaft 150 and linear motion of the rack device 160.

The steering wheel 130 may include a configuration that rotates according to a steering input. In this case, the steering input may include a driver's steering wheel manipulation, a steering wheel rotation signal of an autonomous driving system, and the like.

As an example, the steering wheel 130 may be connected to the upper shaft 140. In this case, force generated as the steering wheel 130 rotates is transmitted to the upper shaft 140, which may affect rotational motion of the upper shaft 140.

The upper shaft 140 may be connected to the steering wheel 130. In this case, force generated as the upper shaft 140 rotates may affect rotational motion of the steering wheel 130.

In addition, the upper shaft 140 may be connected to the steering motor 120. In this case, force generated from the steering motor 120 is transmitted to the upper shaft 140, which may affect rotational motion of the upper shaft 140.

The lower shaft 150 may be connected to the upper shaft 140 and the rack device 160. For example, force generated as the upper shaft 140 rotates may affect rotational motion of the lower shaft 150. In addition, force generated as the lower shaft 150 rotates may affect linear motion of the rack device 160.

As an example, the lower shaft 150 may be a component included in or not included in the steering device 100 depending on the type of the steering device 100.

For example, if the steering device 100 is an Electric Power Steering device, the lower shaft 150 may be included, and in this case, force generated from the upper shaft 140 may affect the lower unit of the steering device through the lower shaft 150.

As another example, if the steering device 100 is a Steer-by-Wire device, the lower shaft 150 may not be included, and in this case, force generated from the upper shaft 140 may not be mechanically transmitted to the lower unit of the steering device. However, in this case, the steering control device 110 may control the lower unit of the steering device 100 through an electronic signal.

The rack device 160 may include a configuration that is connected to the lower shaft 150 and performs linear motion. In this case, the rack device 160 may be connected to the lower shaft 150 through a gear, and rotational motion of the lower shaft 150 may be converted into linear motion in the rack device 160 through such a gear.

As an example, the rack device 160 may be connected to a wheel, and the linear motion of the rack device 160 may affect a change in a traveling direction of the wheel.

As an example, if the steering device 100 is an Electric Power Steering device in which the steering motor 120 is not mounted on the lower unit thereof, the rack device 160 may perform linear motion based on force transmitted through the steering wheel 130, the upper shaft 140, and the lower shaft 150.

As another example, if the steering device 100 has the steering motor 120 mounted on the lower unit thereof, the rack device 160 may perform linear motion based on force generated by driving the steering motor 120 through an electric signal transmitted from the steering control device 110.

The sensor 170 may include a configuration that detects a specific physical phenomenon and converts it into an electric signal. In this case, the sensor 170 may transmit and receive sensing data and the like to and from the steering control device 110 in the form of an electric signal.

As an example, the sensor 170 may include both a sensor provided inside the steering device 100 and a sensor outside the steering device 100. For example, the sensor 170 may include a motor position sensor, a steering angle sensor, a steering torque sensor, and the like provided inside the steering device 100. As another example, the sensor 170 may include a vehicle speed sensor outside the steering device 100, an image sensor including a camera, etc., a laser sensor including a RADAR sensor, a LiDAR, etc., an Inertial Measurement Unit (IMU), an Inclination Sensor, or other environmental sensors sensing weather, temperature, road conditions, and the like.

As an example, the steering device according to the present disclosure may include a configuration for safety design and emergency situation response. For example, major parts such as a steering sensor, a motor, and an ECU may be configured in duplicate, and if a failure of one part among the duplicated configurations occurs, a backup system is automatically activated so that steering control is performed using the remaining one part. In addition, if a failure of the steering system occurs, the steering wheel may be maintained at a neutral position, or control may be performed to stably stop a driving state in conjunction with an Electronic Stability Control (ESC).

As an example, the steering device may include a configuration for controlling according to a preset logic to cope with an emergency situation such as occurrence of a failure. For example, by allowing steering control to be performed through a logic that generates a warning if a failure of the steering device is detected, such as a discrepancy in sensing data (e.g., a discrepancy between a steering wheel angle and a wheel direction), or an emergency steering wheel locking logic such as an electronic lock, it is possible to prevent the steering wheel from rotating rapidly even in an emergency situation.

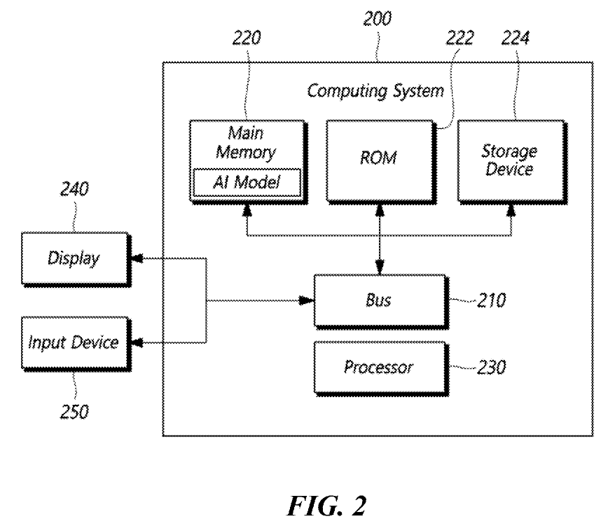

FIG. 2 is a block diagram of an example computer system. The computer system or computing device can include or be used to implement the system or its components such as the data processing system.

The computing system 200 includes a bus 210 or other communication component for communicating information and a processor 230 or processing circuit coupled to the bus for processing information. The computing system 200 can also include one or more processors 230 or processing circuits coupled to the bus 210 for processing information. The computing system 200 also includes main memory 220, such as a random access memory (RAM) or other dynamic storage device, coupled to the bus for storing information, and instructions to be executed by the processor 230. The main memory 220 can be or include the data repository. The main memory 220 can also be used for storing position information, temporary variables, or other intermediate information during execution of instructions by the processor 230. The computing system 200 may further include ROM 222 or other static storage device coupled to the bus for storing static information and instructions for the processor 230. A storage device 224, such as a solid state device, magnetic disk or optical disk, can be coupled to the bus to persistently store information and instructions. The storage device 224 can include or be part of the data repository.

As an example, the computing system 200 may include at least one or more computing devices. For example, it may include various computer devices such as a smartphone, a tablet, a laptop, a desktop, a server, a client, and the like. In this case, the computing device may be a single stand-alone device, or may include a plurality of computing devices operating in a distributed environment in which a plurality of computing devices cooperate with each other through a communication network.

Meanwhile, the computing device may be a classic computing device or a quantum computing device. As an example, the quantum computing device may perform operations in units of Qubits rather than bits. A qubit may have a state in which 0 and 1 are superposed at the same time, and if there are M qubits, 2^M states may be expressed simultaneously.

The quantum computing device may use various types of quantum gates (e.g., Pauli / Rotation / Hadamard / CNOT / SWAP / Toffoli) that receive one or more qubits and perform a designated operation to perform a quantum operation, and may configure a quantum circuit performing a special function by combining quantum gates.

The quantum computing device may use a quantum artificial neural network (e.g., QCNN, QGRNN) capable of performing functions performed by existing artificial neural networks (e.g., CNN, RNN) at a faster speed while using fewer parameters.

In some cases, the computing system 200 may further include a Graphic Processing Unit (GPU). In this case, the GPU may process image data at high speed, and may include a configuration specialized for parallel processing of data, floating point operations, matrix-based operations for learning and inference of artificial intelligence models, and the like.

Data may be stored in the memory, and at least one of a volatile memory (e.g., SRAM, DRAM) or a non-volatile memory (e.g., NAND Flash) may be included. As an example, the memory may include a Random Access Memory (RAM) and a Read-Only Memory (ROM). In this case, the RAM may include all volatile memories capable of reading and writing data, and the ROM may include all non-volatile memories capable of only reading data but retaining data even if the power of the computing system is turned off.

As an example, the data may include all of text, images, executable programs, codes, and the like. In some cases, the data may be stored not only in the memory but also in a separate large-capacity storage server or the like. And below, the main memory 220 may also be referred to as memory (220).

As an example, the memory 220 may be a medium storing computer-readable software, applications, program modules, routines, instructions, and/or data coded to perform a specific task if executed by the processor 230. In addition, the processor 230 may read and execute the computer-readable software, applications, program modules, routines, instructions, and/or data stored in the memory.

In some cases, an artificial intelligence model may be stored in the memory 220. In this case, the artificial intelligence model may include a model on which supervised learning or unsupervised learning is performed. As an example, if supervised learning is performed on the artificial intelligence model, annotation-based learning or data labeling may be further included.

As an example, the computing system 200 may use the artificial intelligence model stored in the memory 220 of the computing system 200 in performing various operations or data classification and generation tasks using the artificial intelligence model. In this case, the steering control device may comprise a memory 220 and a processor 230 as components.

The processor 230 may extract specific data from data stored in the memory 220 or generate new data. For example, the processor 230 may perform a task of classifying at least one preset class from a plurality of images stored in the memory 220. As an example, the processor 230 may execute the artificial intelligence model stored in the memory 220 to perform class classification for each image, and output a class classification result to generate it as new data.

The computing system 200 may be connected to a display 240 and an input device 250. For example, the computing system 200 may be coupled via the bus 210 to a display 240, such as a liquid crystal display or active matrix display, for displaying information to a user. An input device 250, such as a keyboard including alphanumeric and other keys, may be coupled to the bus 210 for communicating information and command selections to the processor 230.

The input device 250 can include a touch screen display. The input device 250 can also include a cursor control, such as a mouse, a trackball, or cursor direction keys, for communicating direction information and command selections to the processor and for controlling cursor movement on the display.

As an example, the input device 250 may include a touch screen display. The input device 250 may also include cursor control, such as a mouse, a trackball, or cursor direction keys, for communicating direction information and command selections to the processor and for controlling cursor movement on the display.

As an example, the display 240 may be a part of a data processing system, a client computing device, or other components. For example, the display 240 may include a visual display device, a printer, a speaker, a vibration device, or the like.

The processes, systems and methods described herein can be implemented by the computing system 200 in response to the processor 230 executing an arrangement of instructions contained in main memory 220. Such instructions can be read into main memory 220 from another computer-readable medium, such as the storage device 224. Execution of the arrangement of instructions contained in main memory 220 causes the computing system 200 to perform the illustrative processes described herein. One or more processors 200 in a multiprocessing arrangement may also be employed to execute the instructions contained in main memory 220. Hard-wired circuitry can be used in place of or in combination with software instructions together with the systems and methods described herein. Systems and methods described herein are not limited to any specific combination of hardware circuitry and software.

Although an example computing system 200 has been described, the subject matter including the operations described in this specification can be implemented in other types of digital electronic circuitry, or in computer software, firmware, or hardware, including the structures disclosed in this specification and their structural equivalents, or in combinations of one or more of them.

A “data processing system”, “computing device”, “module”, “engine”, “component” or “computing device” includes various apparatuses, devices and machines for processing data, including, for example, a programmable processor, a computer, a system on a chip, or a plurality of them, or combinations thereof.

As an example, the processor 230 may include a special purpose logic circuit. For example, it may include a field programmable gate array (FPGA), an application specific integrated circuit (ASIC), a Digital Signal Processor (DSP), Digital Signal Processing Devices (DSPD), a Programmable Logic Device (PLD), and the like.

In some cases, the processor 230 may further include a separate artificial intelligence semiconductor device for processing a task using an artificial intelligence model. For example, the artificial intelligence chip may include a special purpose logic circuit such as an FPGA, an ASIC, a DSP, a DSPD, and a PLD, and may be designed to be specialized for learning or inference tasks using an artificial intelligence model.

For example, the present disclosure may be implemented using an artificial intelligence semiconductor device in which neurons and synapses of a deep neural network are implemented with semiconductor elements. In this case, the semiconductor element may be currently used semiconductor elements, for example, SRAM, DRAM, NAND, etc., or may be next-generation semiconductor elements, RRAM, STT MRAM, PRAM, etc., or may be a combination thereof. Further, when the present disclosure is implemented using an artificial intelligence semiconductor, a result (weight) of learning a deep learning model with software may be transferred to a synapse mimicking element arranged in an array, or learning may be performed in the artificial intelligence semiconductor device.

In addition to such a hardware configuration, code for creating an execution environment for a computer program, for example, code constituting processor firmware, a protocol stack, a database management system, an operating system, a cross-platform runtime environment, a virtual machine, or a combination of one or more thereof may also be included. The apparatus and execution environment may realize various different computing model infrastructures, such as web services, distributed computing, and grid computing infrastructures. As an example, a content request module, a content rendering module, or a rendered content delivery module may include or share one or more data processing devices, systems, computing devices, or processors. Components of the system may include or share one or more data processing devices, systems, computing devices, or processors.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the data processing system) to perform actions by operating on input data and generating output. The processes and logic flows can also be performed by, and apparatuses can also be implemented as, special purpose logic circuitry, e.g., an FPGA (field-programmable gate array) or an ASIC (application-specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor 230 and the memory 220 can be supplemented by, or incorporated in, special purpose logic circuitry.

FIG. 3 is a block diagram regarding another exemplary configuration of a computing system that may be used in the present disclosure.

Referring to FIG. 3, the computing system 300 according to the present disclosure may be connected to a server system 370. For example, the server system 370 may be connected to the computing system 300 according to the present disclosure by wire or wirelessly through a network 360 to transmit and receive data and share computing resources.

As an example, the server system 370 may be built in the form of a cloud system. For example, the server system 370 may include a configuration that allows individual computing devices to access the server system 370 through a network 360 and shares computing resources with the connected computing devices. In this case, the individual computing device may access the cloud system from anywhere in an environment where a network such as the Internet is connected.

As an example, the cloud system may elastically expand or reduce and provide computing resources as needed, and may share such computing resources with other computing devices connected through a network. In addition, the cloud system may be built based on various service models such as IaaS (Infrastructure as a Service), PaaS (Platform as a Service), and SaaS (Software as a Service) depending on the purpose or scope of use.

As an example, the cloud system may include at least one or more computing devices, storage devices, and network devices, respectively. Each computing device included in the cloud system may include a processor 374 and a memory 372 for processing various computing tasks, the storage device may include a configuration related to data storage such as a HDD (Hard Disk Drive), an SSD (Solid State Drive), a NAS (Network Attached Storage), or a SAN (Storage Area Network) for storing large-capacity data, and the network device may include a networking-related configuration such as a switch, a router, a load balancing device, and a firewall.

As an example, the computing system 300 may use the artificial intelligence model stored in the memory 320 of the computing system 300 in performing various operations or classification and generation tasks of data using the artificial intelligence model. In this case, the steering control device may comprise a memory 320 and a processor 330 as components.

Alternatively, in some cases, the computing system 300 may share computing resources from the cloud system and use an artificial intelligence model stored in the cloud system. In this case, even if the computing system does not directly possess a configuration related to the artificial intelligence model by itself, it may process related tasks using the artificial intelligence model provided from the cloud system. For example, the server system 370 may use an artificial intelligence model stored in the memory 372, and the computing system 300 may access the server system 370 via a network 360 and use the artificial intelligence model stored in the memory 372. In this case, the steering control device may comprise a memory 372 and a processor 374 as components.

As an example, the steering control device includes at least one memory including computer program instructions, and at least one processor executing the computer program instructions, wherein the at least one processor generates steering type information of a driver based on driving data of a vehicle using a steering type classification model, extracts steering pattern information of the driver from the driving data using a pattern extraction model, generates a steering profile for the driver based on the steering type information and the steering pattern information, generate steering control information based on the steering profile of the driver and a steering input of the driver and controls a steering device according to the steering control information.

Further, in the present disclosure, “data, value, condition, range, etc. are preset” may include all of a method in which specific data or values are input and set in advance during system design or product production, a method in which data or values stored in a specific storage space or received from other components are input and set, a method in which a user directly inputs and sets them through an input means such as a prompt, and the like.

As an example, the driving data may include steering data, vehicle state data, driving environment data, and the like. In this case, the driving data may be received in the form of an electric signal through a physical or electrical connection with a sensor installed in the vehicle, another computing system, or a processor. In some cases, the driving data may be transmitted or streamed in real-time.

As an example, the steering data may include data regarding a steering wheel rotation angle and direction, a steering wheel rotation speed, a force or torque generated by steering wheel manipulation, a feedback torque generated by a steering motor, a road wheel steering angle and direction, a road wheel steering angular velocity, a force applied to a rack device or a road wheel, and the like.

As an example, the vehicle state data may include all data regarding the state of the vehicle, such as vehicle speed, acceleration and whether acceleration/deceleration is performed, yaw/roll/pitch angles of the vehicle, and inclination and lateral acceleration of the vehicle during cornering driving.

As an example, the environment data may include data regarding a road surface friction coefficient related to a road environment around the vehicle, a tire slip ratio, external temperature and weather information, a slope of a road, and the like.

As an example, the processor may generate steering type information of the driver based on the driving data of the vehicle. In this case, the steering type information of the driver may be generated using a steering type classification model.

As an example, the steering type classification model may generate the steering type information of the driver by determining one of a plurality of steering types corresponding to each of a plurality of clusters generated through clustering of the driving data.

As an example, the steering type classification model may include a model pre-trained to cluster a plurality of data points corresponding to the driving data and classify the steering type of the driver into one of K steering type groups.

For example, the steering type classification model may include a configuration for clustering driving data using a clustering-based algorithm such as K-Means or DBSCAN (Density-Based Spatial Clustering of Applications with Noise). In this case, the steering type classification model performs initial clustering on data points based on driving data based on a steering speed and a rotation angle using a clustering-based algorithm, and classifies each driver to be included in one of steering type groups (e.g., a sensitive steering type group, a stable driver type group, etc.) based on result data obtained by performing the initial clustering in connection with vehicle speed data.

As an example, the steering type classification model may include a model pre-trained to find an optimal boundary line between steering type groups and classify data in consideration of characteristics of individual drivers with respect to data points based on clustered driving data.

For example, the steering type classification model may perform an optimal classification task for data points based on an optimal classification algorithm of data such as SVM (Support Vector Machine). In this case, the steering type classification model may model a non-linear relationship between a steering resistance value and a vehicle speed using SVM and an optimal classification algorithm, and perform a task of optimally classifying driving data regarding each driver into one of steering type groups in consideration of characteristics of individual drivers.

As an example, the processor may extract steering pattern information from the driving data of the vehicle. In this case, the steering pattern information may be extracted using a pattern extraction model.

As an example, the pattern extraction model may extract the steering pattern information by performing a time-series analysis on a relationship between the steering input of the driver and the driving data. In this case, the driving data may include data in the form of time-series data in which various data items that can be classified into steering data, vehicle state data, road environment data, etc. are included according to temporal continuity.

As an example, the pattern extraction model may include a model trained to find a portion where data of various items such as a steering angle, an angular velocity, and a vehicle speed follow a specific order, arrangement, or rule from driving data including such time-series data, analyze a driving situation, and extract steering pattern information.

For example, the pattern extraction model may include an LSTM (Long Short-Term Memory) model to perform a time-series analysis on the driving data of the driver, and through this, determine a driving situation in a corresponding time-series portion and extract steering pattern information.

As an example, the steering pattern information may be extracted in a form including a reaction and a steering output of the steering device corresponding to a specific steering input, and based on a correspondence relationship between such a steering input and the reaction and output of the steering device, it is possible to analyze what steering reaction parameter the driver preferred in what driving situation. Through this, the pattern extraction model may analyze how personalized steering input, driving situation, steering reaction parameter, and steering output correspond to each other for each driver.

As an example, the processor may generate a steering profile for each driver based on the steering type information and the steering pattern information. In this case, the steering profile may include a preset parameter for generating information regarding a steering output corresponding to a steering input.

As an example, the steering profile may include a steering reaction parameter for generating steering control information by applying the steering reaction parameter to the steering input of the driver. In this case, the at least one processor may generate the steering profile such that the steering reaction parameter is set for each driving situation.

As an example, the processor may generate steering control information for generating a steering reaction and a steering output according to a steering type and a steering pattern appearing in driving data of a specific driver based on steering type information and steering pattern information of the corresponding driver.

To this end, a steering profile generated based on steering type information and steering pattern information of a specific driver is generated, and if there is a steering input of the corresponding driver, a steering reaction parameter included in a corresponding steering profile is applied, so that steering control can be performed such that a steering reaction and a steering output reflecting the steering type and steering pattern of the corresponding driver are achieved.

As an example, the steering reaction parameter may include a steering sensitivity for determining a steering angle of a road wheel corresponding thereto by being applied to a rotation angle of a steering wheel appearing by a steering input, a feedback intensity for determining a feedback torque corresponding thereto by being applied to a steering wheel manipulation, a neutral restoring force applied if force supply by a steering wheel manipulation is stopped, and the like.

As an example, the driving situation may be determined based on at least one of steering data, vehicle state data, and driving environment data included in the driving data. In this case, the at least one processor may determine the driving situation based on a vehicle state identifiable from the driving data, an environment around the vehicle, or the like.

As an example, the processor may determine the driving situation as one of a high-speed driving situation and a low-speed driving situation based on vehicle speed data included in the driving data. For example, the processor may determine it as a high-speed driving situation if the vehicle speed data is equal to or greater than a preset reference vehicle speed, and as a low-speed driving situation if it is less than the reference vehicle speed.

In some cases, the reference vehicle speed may be set differently according to the steering type of the driver or contents of other driving data items other than the vehicle speed data. For example, drivers with different steering types may have reference vehicle speeds set differently from each other. As another example, if the road surface friction coefficient is less than a threshold friction coefficient, the reference vehicle speed may be set differently from if it is equal to or greater than the threshold friction coefficient.

As an example, the processor may determine the driving situation based on road surface friction coefficient data included in the driving data. For example, if the road surface friction coefficient is equal to or greater than the threshold friction coefficient, it may be determined as a dry road driving situation, and if it is less than the threshold friction coefficient, it may be determined as a slippery road driving situation. In some cases, more detailed driving situation determination may be performed, such as determining it as a dry road driving situation if the road surface friction coefficient is equal to or greater than a first threshold friction coefficient, as a rainy road driving situation if it is less than the first threshold friction coefficient and equal to or greater than a second threshold friction coefficient, and as an icy road driving situation if it is less than the second threshold friction coefficient.

In addition, the processor may determine the driving situation based on various data included in the driving data, and in some cases, may determine that it corresponds to two or more driving situations at one time point. For example, the processor may determine the driving situation as corresponding to both a "high-speed driving situation" and a "slippery road driving situation" with respect to driving data at a specific time point.

As an example, the processor may generate steering control information based on the steering profile of the driver and the steering input. Further, the processor may control the steering device according to the steering control information.

As an example, the steering control information may include road wheel steering control information regarding at what speed and to which position the road wheel is to be steered in response to the steering input of the driver, feedback torque control information for assisting a steering input at the steering wheel or providing a reaction force, neutral restoring force control information regarding at what speed and with what intensity the steering wheel is to be restored to neutral when the steering input is stopped, and the like.

In some cases, the processor may correct the steering control information. In this case, the processor may allow correction of the steering control information to be performed when a specific condition is satisfied, or may perform correction of the steering control information based on a driving environment analysis such as a road state. For example, the processor may correct the steering control information based on a result of determining the driver's steering intent, or may correct the steering control information based on whether a specific condition set using the driving data is satisfied, or may correct the steering control information by considering both the result of determining the steering intent and whether the specific condition is satisfied.

As an example, the at least one processor may determine steering intent of the driver by comparing the steering input of the driver with the steering pattern information, and determine, based on the steering intent and a driving situation determined from the driving data, whether steering correctionis to be performed. In this case, the at least one processor may correct the steering control information in response to determining that steering correction is to be performed.

As an example, the at least one processor may determine the steering intent as a normal steering intent in response to the steering input being within a normal steering range according to the steering pattern information. As another example, the at least one processor may determine whether the steering intent is a risk avoidance intent or a mistake based on the driving situation in response to the steering input being outside the normal steering range.

In this case, the "steering intent" referred to in the present disclosure may be described as one of data processing results of the processor generated based on the driver's steering input during vehicle driving and collected steering data, rather than the driver's mental action itself.

For example, the steering intent may be described as result data determined through data processing such as Pattern Matching and Vector Operation based on information collected from vehicle sensors (e.g., steering angle sensor, steering torque sensor, vehicle speed sensor, etc.) and based on a specific rule set in advance (e.g., restriction conditions, rules, etc. included in the steering profile) or a normal steering range set to a specific value, the driver's existing driving pattern, etc.

As an example, the processor may determine whether the steering input of the driver is outside the normal steering range on the steering pattern information appearing in the driving data of the corresponding driver. In this case, the normal steering range may be a value determined based on at least one of the driver's past driving data or a preset normal steering range setting value, and in some cases, may be a range value determined as a range between a normal range maximum value and a normal range minimum value for each steering parameter.

For example, the processor may determine that the steering intent is a normal steering intent if it is determined that the steering input of the driver is within the normal steering range, and may determine that the steering intent is not a normal steering intent if it is determined that the steering input is outside the normal steering range.

As an example, if it is determined that the steering input of the driver is not a normal steering intent, the processor may determine whether the corresponding steering input is made with a risk avoidance intent or by mistake in consideration of the driving situation.

As an example, if a rapid steering input deviating from the driver's existing driving pattern by a certain amount or more is made, the steering intent according to the corresponding steering input may be determined differently depending on the driving situation. For example, if the driving situation when the corresponding steering input is made is a situation where a front obstacle is detected or a sharp curve is required on road information, the steering intent may be determined as a risk avoidance intent, and if there is a rapid steering input even though such circumstances are not seen in the driving situation, it may be determined as being caused by a mistake.

As an example, the processor may compare the steering intent of the driver with the driving state of the vehicle, and correct the steering control information if it is determined that driving according to the corresponding steering intent is not performed.

For example, if it is determined that the steering intent according to the steering input of the driver is a normal steering intent, but it is determined that normal steering in which the vehicle state according thereto matches such a normal steering intent is not being performed, it may be determined that correction of the steering control information is necessary.

As another example, if it is determined that the steering intent according to the steering input of the driver is a risk avoidance intent, but it is determined that the vehicle state according thereto indicates that steering for risk avoidance is not sufficiently performed, it may be determined that correction of the steering control information is necessary.

As another example, if it is determined that the steering intent according to the steering input of the driver was a mistake, correction of the steering control information for preventing an accident risk due to a mistake may be performed in principle, but if performing steering control according to the steering input due to the corresponding mistake does not significantly affect driving safety (e.g., a situation where the vehicle is stopped or driving at a very low speed), correction of the steering control information may not be performed.

The processor may determine whether correction of the steering control information is necessary in consideration of the analysis result of the steering intent according to the steering input of the driver and the driving situation determined based on the driving data as described above, and in some cases, specific conditions for determining whether correction is necessary may be set.

As an example, the at least one processor may determine that steering correction is to be performed in response to a correction threshold condition, which is set according to the steering intent being satisfied.

For example, the processor may set a plurality of conditions such as a condition where the vehicle speed of the vehicle is equal to or greater than a threshold vehicle speed, a condition where the steering angular velocity is equal to or greater than a threshold angular velocity, and a condition where the road surface friction coefficient is equal to or greater than a threshold friction coefficient, and set the correction threshold condition so that it is determined that correction is necessary if at least x or more of these conditions are satisfied.

Further, the processor may set the correction threshold condition in a manner that sets the threshold vehicle speed, the threshold angular velocity, the threshold friction coefficient, etc. differently according to the steering intent of the driver. In addition, the correction threshold condition may be set differently by further considering not only the steering intent but also the steering type of the driver or the driving situation of the vehicle. Through this, while providing a steering reaction and a steering output suitable for the steering type and steering pattern of the driver in a normal driving situation, steering correction control can be performed more quickly and accurately according to specific conditions corresponding thereto if a situation with a relatively high accident risk occurs.

As an example, the at least one processor may estimate a road surface friction coefficient based on sensing data. For example, the at least one processor may estimate road surface friction coefficient information by fusing road sensing data received from at least two or more sensors.

As an example, the processor may detect the road surface friction coefficient through sensor fusion. For example, the road surface friction coefficient can be estimated more accurately by fusing sensing data of a road surface friction sensor inside a tire, a camera and a LiDAR mounted on a lower portion of the vehicle, and the like. In some cases, a road state such as whether it is an icy road or a wet road may be detected using an AI-based road database.

As an example, the at least one processor may correct the steering control information based on the road surface friction coefficient information. In some cases, if correcting the steering control information in an instance where it is determined that steering correction is necessary based on the driver's steering intent and a driving situation, the processor may further consider the estimated road surface friction coefficient information. For example, the processor may correct the steering control information if both i) a condition for determining that steering correction is necessary based on the steering intent and ii) a condition for determining that steering correction is necessary based on the estimated road surface friction coefficient information are satisfied.

As an example, the at least one processor may correct the steering control information based on a relatively decreased steering sensitivity in response to the road surface friction coefficient information being less than a first threshold friction coefficient. For example, the processor may correct the steering control information based on a steering sensitivity having a value relatively lower than a reference sensitivity set in the steering profile. As another example, the processor may correct the steering control information based on a steering sensitivity determined as a low value among a plurality of steering sensitivity setting values set in the steering profile.

As another example, the at least one processor may correct the steering control information based on the decreased steering sensitivity while limiting steering behavior within a preset maximum steering behavior range in response to the road surface friction coefficient information being less than a second threshold friction coefficient less than the first threshold friction coefficient.

For example, if the road surface friction coefficient information is estimated in a range of 0 to 1, the first threshold friction coefficient is set to 0.7, and the second threshold friction coefficient is set to 0.3, the processor may determine whether to correct the steering control information according to the estimated road surface friction coefficient information, and may correct the steering control information in a manner of applying a decrease in steering sensitivity and a maximum steering behavior range.

As an example, if the road surface friction coefficient information is estimated to be 0.9, the processor may determine that correction of the steering control information based on the road surface friction coefficient information is not necessary based on the fact that it is equal to or greater than the first threshold friction coefficient of 0.7.

As another example, if the road surface friction coefficient information is estimated to be 0.6, the processor may correct the steering control information by applying a steering sensitivity relatively decreased compared to the steering sensitivity according to the steering profile of the corresponding driver based on the fact that it is less than the first threshold friction coefficient of 0.7 but equal to or greater than the second threshold friction coefficient of 0.3.

As another example, if the road surface friction coefficient information is estimated to be 0.2, based on the fact that it is less than the first threshold friction coefficient of 0.7 and also less than the second threshold friction coefficient of 0.3, the processor may apply a steering sensitivity relatively decreased compared to the steering sensitivity according to the corresponding steering profile, but if such an application result exceeds the maximum steering behavior range, correct the steering control information to a value within the maximum steering behavior range. For example, the steering control information may be corrected to a maximum value within the maximum steering behavior range.

The processor may control the steering device according to the steering control information. As an example, if the steering control information is corrected, the steering device may be controlled according to the corrected steering control information, and if the steering control information is not corrected, the steering device may be controlled according to the steering control information as generated based on the steering profile and the steering input.

Through this, the processor may control the road wheel to be steered to a specific position at a specific speed according to the generated steering control information as it is or according to the corrected steering control information if there is a steering input of the driver, control the steering motor to generate a feedback torque corresponding to the steering input at the steering wheel, and control the physical linear motion of the rack device through the steering motor control. In some cases, the processor may perform steering control such as controlling neutral restoration of the steering wheel to be performed at a specific speed and intensity if the steering input is stopped. That is, through the steering control as described above, the processor may cause the steering angle, steering torque, etc. of the vehicle to be physically changed according to the steering control information.

As an example, the present disclosure may be implemented within a vehicle system including a hardware configuration and a software configuration.

As an example, the hardware configuration of the vehicle system may include a control unit (ECU) that processes a steering input and performs steering device control such as adjusting an operation sensation (resistance, reaction force) of a wheel in real-time, a sensor module including a steering sensor measuring a steering angle, speed, resistance, etc., a speed sensor providing vehicle speed data, an acceleration sensor sensing a movement change of the vehicle, an environmental sensor (e.g., camera, radar) sensing a road state and weather, etc., a driver identification module performing user profile identification through biometric authentication (face, fingerprint, voice) or a smart key, and a storage device including a local storage in the vehicle and a cloud server (driving style storage and update).

As an example, the software configuration of the vehicle system may include a data collection module that collects and records sensor data in real-time during driving, a data analysis and learning algorithm that performs machine learning-based driving style analysis and profile generation, a steering device control algorithm that adjusts reaction characteristics (resistance, restoring force) of the steering wheel according to the analyzed profile, a UI and user feedback module that provides an interface through which a driver can set a profile or input feedback, and the like.

As an example, the processor may perform an operation of analyzing the driver's driving style, preference, driving condition, etc. based on data, and generating and applying a steering profile based on a personalized steering reaction. For example, the processor may generate a personalized steering profile through a process of identifying a driver, collecting data, and analyzing a driving style, and store, apply, and update the generated steering profile.

As an example, the processor may perform a driver identification process of executing a process for driver recognition when boarding the vehicle. For example, the processor may identify a user with a smart key or driver's seat biometric authentication, start with a basic profile if the driver is a new user and collect driving data based thereon, and perform an operation of loading a stored profile if the driver is an existing user.

The processor may perform a data collection process of collecting behavior data of the vehicle and the driver in real-time during driving. For example, the processor may perform a data collection process including a basic data collection and preprocessing step of collecting driving data (behavior data of the vehicle and the driver) in real-time and preprocessing it, a real-time filtering and outlier removal step, and a data pattern analysis (Feature Engineering) step.

As an example, in the data collection and analysis structure, the processor may go beyond simply utilizing static data such as steering angle and speed to generate a profile, and use a multi-layer data analysis structure reflecting the dynamic environment of the vehicle and real-time feedback of the driver.

As an example, the basic data collection and preprocessing step may include collecting steering data, vehicle data, and environment data and performing certain data processing.

As an example, the steering data may include data regarding a driver's steering input, a steering angle and a steering angle change through a steering angle sensor, a steering wheel angular velocity, a steering direction (left/right), etc., data regarding a force applied to a handle by the driver and steering intent through a steering torque sensor, data regarding other steering restoring force, steering reaction time, etc.

As an example, the processor may determine whether the driver rotates the handle quickly, moves it slowly, or suddenly releases the handle through steering data analysis. For example, if steering data indicates that the driver rotates the steering wheel 30 degrees to the left and the rotation speed is 20 degrees/s, the processor may analyze whether it is an unusual rapid steering based on such steering data.

As an example, the vehicle data may include speed data through a vehicle speed sensor, data regarding whether it is low speed or high speed, data regarding an inclination, yaw/roll/pitch angles, etc. of the vehicle through an IMU (Inertial Measurement Unit) including an accelerometer, a gyroscope sensor, etc., data regarding other acceleration/deceleration patterns, an inclination and lateral acceleration of the vehicle during cornering, etc.

As an example, the processor may determine whether the vehicle is making a sharp curve or driving at high speed through vehicle data analysis. For example, if the vehicle speed is shown to be 100 km/h through the vehicle speed data, the processor may determine it as a high- speed driving situation, and based on this, determine that it is necessary to adjust the steering sensitivity sensitively during subsequent steering profile generation or correction of steering control information.

As an example, the environment data may include data regarding road surface friction force or friction coefficient (whether it is wet road, snowy road, icy road) through a road surface state sensor, tire slip ratio, etc., data regarding road slope, weather (rain, snow, etc.) collected using other sensors, etc.

As an example, the processor may determine whether the road is slippery due to a low friction coefficient, whether the road slope is high, etc. through environment data analysis, and based on this, determine that it is necessary to adjust the steering reaction parameter so that steering is performed stably during subsequent steering profile generation or correction of steering control information.

As an example, the processor may reflect user feedback such as a steering setting change directly adjusted by the driver, and transmit the collected data to the ECU and the cloud server to record it.

As an example, the real-time filtering and outlier removal step may include removing noise using a filtering technique in the vehicle sensor and the cloud server, and detecting an abnormal rapid steering change to remove abnormal data.

As an example, the processor may perform filtering and outlier removal using a Kalman Filter, Gaussian Smoothing, Low-pass Filter, and the like. For example, a Low-pass Filter may be applied for noise removal, and a Kalman Filter may be used to correct sensor errors.

As an example, the data pattern analysis step may include analyzing a driving pattern over time to classify the pattern, adjusting data weights according to a driving environment (highway, city center, parking lot), and analyzing a correlation between a steering pattern and environment variables.

The processor may perform a driving style analysis and profiling process of analyzing the collected data with an AI learning model or a machine learning algorithm to extract characteristics of the driver.

As an example, the processor may analyze a driving pattern based on the driving data. For example, the processor may identify a driving pattern using a time-series analysis model such as an LSTM-based neural network, learn a steering style of an individual driver and provide customized steering settings, and learn long-term driving data to analyze a continuous pattern of a specific driver. Further, such a driving pattern analysis result may be used to automatically reflect steering adjustment accordingly if the driver is tired or the driving style changes.

As an example, the driving pattern or driving pattern type according to the driving pattern analysis may be classified into various types according to various criteria.

For example, the driving pattern may be extracted and classified into a fast steering pattern classified as an agile style of the driver's characteristics, a slow steering pattern classified as a stable and cautious style, a high-speed steering pattern in the case of a style with low steering sensitivity, a low-speed steering pattern in the case of preferring a sensitive reaction, and the like.

As an example, the processor may perform analysis and learning on the driving data using an AI learning model or a machine learning model.

For example, the processor may perform time-series analysis and pattern learning on the driving data using an LSTM model.

As another example, the processor may proceed with initial clustering based on steering speed and rotation angle using a K-means clustering-based model, and analyze it in connection with vehicle speed to distinguish and estimate a sensitive driver and a stable driver. Further, a non-linear relationship according to a steering resistance value and a driving speed may be modeled using an SVM (Support Vector Machine)-based model, and optimal classification for a steering profile may be performed in consideration of characteristics of each driver. In addition, a clustering model such as DBSCAN (Density-Based Spatial Clustering of Applications with Noise) may be used.

The processor may perform a personalized profile generation process in which the machine learning model generates a steering profile based on the analysis result. For example, the processor may generate a steering profile including a steering sensitivity for adjusting a rotation amount of the steering wheel and a direction change ratio of the vehicle, a feedback intensity for adjusting a resistance force (steering weight) during wheel rotation, a neutral restoring force for adjusting a magnitude of a force restoring the steering wheel to an original position, and reactions for each environment for dynamic setting according to other city center, highway, and parking situations.

As an example, the processor may set the steering reaction parameter in a driver-customized manner. For example, the processor may perform personalized adjustment on steering reaction parameters including a steering sensitivity for adjusting a rotation amount of the steering wheel and a direction change ratio of the road wheel, a feedback intensity for adjusting a resistance force (steering weight) during wheel rotation, a neutral restoring force for adjusting a magnitude of a force restoring the steering wheel to an original position, and the like.

As an example, the processor may set the steering reaction parameter for each of various driving situations such as a high-speed driving situation, a low-speed driving situation, and a sharp curve driving situation. In this case, the processor may set the steering reaction parameter in a manner of relatively decreasing or increasing parameters such as steering sensitivity, neutral restoring force, and steering resistance value according to the driving situation. For example, the processor may determine a setting value of a steering sensitivity item included in the steering reaction parameter based on one of a reference sensitivity set in the steering profile, a sensitivity relatively lower than the reference sensitivity, and a sensitivity relatively higher than the reference sensitivity according to the driving situation. As another example, the processor may determine a setting value of a steering sensitivity item included in the steering reaction parameter based on one of a plurality of steering sensitivity setting values set in the steering profile according to the driving situation. Further, regarding the neutral restoring force and the steering resistance value as well as the steering sensitivity, the processor may determine setting values of a neutral restoring force item and a steering resistance value item included in the steering reaction parameter according to the driving situation like the steering sensitivity described above.

As an example, in a high-speed driving situation such as a highway, the processor may set the steering reaction parameter in a direction of relatively decreasing the steering sensitivity and relatively increasing the neutral restoring force to secure straight driving stability.

For example, in a high-speed driving situation, it is possible to set the road wheel rotation to react only 1 degree to a 5-degree change in steering angle, thereby reinforcing straightness during highway driving and allowing fine manipulation to be reflected. In this case, a preset algorithm such as a speed-based steering sensitivity adjustment function may be applied so that more stable control is performed.

As an example, in a low-speed driving situation such as city driving, the processor may set the steering reaction parameter in a direction of relatively increasing the steering sensitivity and relatively decreasing the neutral restoring force to secure quick responsiveness and decrease a manipulation amount of the steering wheel.

For example, in a low-speed driving situation, it is possible to set the road wheel rotation to react 3 to 5 degrees to a 5-degree change in steering angle, thereby supporting flexible handling at low speed. In this case, a preset algorithm such as a steering amplification function at low speed may be applied so that more efficient control is performed.

In some cases, in a parking situation among low-speed driving situations, the processor may relatively decrease the steering resistance value and set the steering reaction parameter so that smoother manipulation is possible.

As an example, if the user has a driving style of frequently moving between a highway and a city center, the processor may analyze that the user prefers to relatively lower the steering sensitivity on the highway (small steering movement) and prefers fast rotation and sensitive responsiveness in the city center in the data collection and analysis process, generate a profile based on the analysis result in the profile generation process, for example, set the vehicle direction to change by 2 degrees per 10-degree change in steering wheel angle on the highway and set the vehicle direction to change by 5 degrees per 10-degree change in steering wheel angle in the city center, and control to automatically lower the steering sensitivity if the vehicle enters the highway and immediately increase the steering sensitivity if switching to driving in a city section in the application process of the generated profile.

As such, in performing the personalized profile generation process, the processor may generate a dynamic profile reflecting the driver's style and continuously update it, and generate a steering profile such that driver-customized steering setting parameters based on machine learning analysis results are applied.

As an example, the processor may perform a profile storage and application process. For example, the processor may store the generated profile in the local memory of the vehicle and the cloud server, and allow the corresponding profile to be automatically applied if the driver uses the vehicle later. To describe a more specific example, through application of the steering profile, the processor may provide a personalized steering reaction according to the driving situation by decreasing steering sensitivity and increasing stability in a highway driving situation, increasing steering sensitivity and maintaining quick responsiveness in a city driving situation, and allowing smooth steering manipulation at low speed in a parking driving situation.

As an example, the processor may perform a profile update process of continuously learning driving data to improve the steering profile. For example, the processor may update an existing steering profile through learning on newly collected driving data. In some cases, the update of the steering profile may be performed in a manner in which the driver manually adjusts settings.

As such, the present disclosure generates a personalized steering profile for each driver according to driving data collection and analysis, and through a configuration for applying and updating it, allows adaptation to a driving environment such as dynamic adjustment according to weather, road conditions, and time zone (night/day), supports a multi-user and multi-vehicle environment by automatically loading each user profile during vehicle sharing, and provides cloud-based OTA updates to continuously improve algorithms and related processes.

The processor may perform steering correction control according to steering intent analysis. For example, the processor may analyze the driver's steering intent, determine whether steering correction is necessary, and generate a steering correction signal to apply it to steering control.

As an example, the processor may analyze the driver's steering intent by analyzing a direction and purpose in which the driver intends to steer, comparatively analyzing a steering speed and angle, and determining whether it is risk avoidance or a mistake if rapid steering is performed.

As an example, the processor may analyze the direction and purpose in which the driver actually intends to steer by recording the driver's steering pattern and comparing the existing steering pattern with a current steering input to determine whether it is sudden steering or normal steering. In this case, the steering pattern may be learned based on artificial intelligence (AI) or machine learning.

As an example, the processor may comparatively analyze the steering speed and angle by analyzing driving data to determine whether the steering speed and angle according to the driver's steering input correspond to rapid steering (e.g., rotating rapidly by 90° or more), continuous fine steering, etc.

As an example, the processor may determine whether rapid steering is risk avoidance or a mistake by analyzing a specific driving situation appearing in the driving data. For example, if the brake is suddenly applied together with steering, it may be determined that the possibility of risk avoidance is high, if a driver who usually steers smoothly suddenly steers rapidly at 90°, it may be determined that the possibility of risk avoidance is high, and if a rapid steering wheel movement occurs during high-speed driving, it may be determined as a situation where the possibility of a mistake is high and at the same time the accident risk is high unless there are special circumstances such as detection of a road curve or an obstacle ahead.

As an example, the processor may determine whether steering correction is necessary by analyzing a steering state of the vehicle and determining whether to correct based thereon. In this case, the processor may compare the driver's steering intent with the vehicle state to determine whether steering correction is necessary.

For example, if it is determined as normal steering as a result of comparing the steering intent and the vehicle state, in a case where the vehicle steers slowly while reversing at low speed, etc., the processor may perform steering control using initially generated steering control information without steering correction.

As another example, if it is determined through driving data and steering intent analysis that the vehicle is slipping, or even if not, the road is slippery, if it is determined that the change in steering angle is rapid by a certain amount or more, or if the driver rotates the steering wheel rapidly during high-speed driving, the processor may determine that steering correction is necessary.

As an example, the processor may determine whether steering correction is necessary based on a steering correction necessity determination algorithm. In this case, the steering correction necessity determination algorithm may include a logic for determining a risk threshold or a risk determination condition set based on items such as steering speed, vehicle speed, and road surface friction force.

As an example, the risk threshold may include a steering speed threshold for determining whether steering is rapid, a vehicle speed threshold for determining whether driving is at high speed, and a road surface friction coefficient threshold for determining whether driving is on a slippery road. Further, the processor may determine whether steering correction is necessary based on a condition satisfying at least two or more, or three or more of the plurality of risk thresholds as described above. For example, if all of a condition where the steering speed is 60°/s or more, a condition where the vehicle speed is 80 km/h or more, and a condition where the road surface friction coefficient is less than 0.4 are satisfied, it may be determined that steering correction is necessary.

As an example, if it is determined that steering correction is necessary, the processor may generate a steering correction signal and apply it to steering control. For example, the processor may generate a steering correction signal in a direction of increasing steering stability by relatively decreasing steering sensitivity in a high-speed driving situation and increasing convenience of steering manipulation by relatively increasing steering sensitivity in a low-speed driving situation with respect to an electronic steering ratio.

In some cases, the processor may generate a steering correction signal and allow it to be linked with an ESC (Electronic Stability Control) system, so that ESC intervention is performed if tire slip is detected to perform steering correction control such as adjusting wheel speed. Separately from this, if it is determined that steering correction is necessary, the processor may cause a strong resistance force to be generated through haptic feedback torque control on the steering wheel, or cause vibration to be generated on the steering wheel to induce the driver's steering correction, or control a warning system using a warning light, a warning sound, etc. to be activated.

As an example, if the processor determines that steering correction is necessary and generates a steering correction signal, it may transmit the corrected steering signal to the steering device. Through this, the steering motor and the like are controlled according to the corrected steering signal, and the ESC system can be controlled to be linked. In some cases, it is possible to determine whether re-correction is necessary by monitoring a control process according to the corrected steering signal in real-time. For example, as a result of re-measuring a road wheel rotation angle corresponding to a steering input, if a difference of a certain amount or more occurs even though it is a control result according to the corrected steering signal, additional steering correction may be performed.

The processor may perform adaptive control based on road state. For example, the processor may determine a road state to detect a road surface friction coefficient, and perform adaptive steering control based on driving data input in real-time.

As an example, the processor may detect the road surface friction coefficient through sensor fusion. For example, the road surface friction coefficient can be estimated more accurately by fusing sensing data of a road surface friction sensor inside a tire, a camera and a LiDAR mounted on a lower portion of the vehicle, and the like. In some cases, a road state such as whether it is an icy road or a wet road may be detected using an AI-based road database.

As an example, the processor may correct steering control information based on the road surface friction coefficient. For example, in a dry road driving situation where the road surface friction coefficient is set to 0.7 or more, control may be performed so that steering of the vehicle is performed based on steering control information generated based on a basic steering reaction parameter based on a steering profile. As another example, in a wet road driving situation where the road surface friction coefficient is set to 0.3 or more and less than 0.7, steering control for preventing slipping of the vehicle may be performed by adjusting the steering sensitivity to be relatively decreased. As another example, in an icy road driving situation where the road surface friction coefficient is set to less than 0.3, steering control may be performed so that accidents can be prevented at a higher level by limiting the maximum steering force together with the adjustment of the steering sensitivity described above.

In this case, a preset algorithm such as a friction coefficient-based steering correction function may be applied so that more accurate and stable control is performed.

As an example, the processor may receive driving data including speed (V), steering angle (θ), yaw rate, road surface state, etc. in real-time, and based on this, allow steering control to be performed more precisely using a feedback-based control algorithm such as PID (Proportional-Integral-Derivative) control. To this end, steering control performance can be improved by optimizing PID parameters based on driving data and the driver's steering type, steering pattern, etc. analyzed based thereon.

For example, the processor may perform adaptive steering control in a direction of preventing understeer by providing steering assist torque if entering a sharp curve on road state data, and improving steering stability in a high-speed driving situation.

Hereinafter, a steering control method using a steering control device capable of performing all the contents described above in the present disclosure will be described, and contents overlapping with those described above may be omitted in some cases, but may be all applied in terms of the method below.

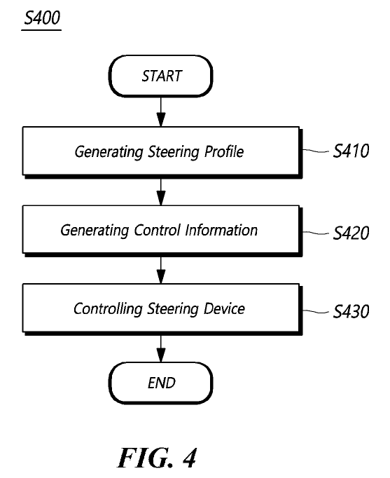

FIG. 4 is a flowchart regarding a steering control method according to an embodiment.

Referring to FIG. 4, a steering control method (S400) according to an embodiment may include generating a steering profile (S410), generating steering control information (S420), and controlling a steering device (S430).

As an example, the steering control method (S400) may include generating steering type information of a driver based on driving data of a vehicle using a steering type classification model, extracting steering pattern information of the driver from the driving data using a pattern extraction model, and generating a steering profile for the driver based on the steering type information and the steering pattern information, generating steering control information based on the steering profile of the driver and a steering input of the driver, and controlling a steering device according to the steering control information.

Generating a steering profile (S410) may include generating steering type information based on driving data, extracting steering pattern information, and generating a steering profile based on the steering type information and the steering pattern information.

As an example, generating a steering profile (S410) may include generating steering type information using a steering type classification model. In this case, the steering type classification model may generate the steering type information of the driver by determining one of a plurality of steering types corresponding to each of a plurality of clusters generated through clustering of the driving data.

As an example, generating a steering profile (S410) may include extracting steering pattern information using a pattern extraction model. In this case, the pattern extraction model may extract the steering pattern information by performing a time-series analysis on a relationship between the steering input of the driver and the driving data.

As an example, generating a steering profile (S410) may include generating a steering profile for each driver based on the steering type information and the steering pattern information. In this case, the steering profile may include a preset parameter for generating information regarding a steering output corresponding to a steering input.

As an example, the steering profile may include a steering reaction parameter for generating steering control information by applying the steering reaction parameter to the steering input of the driver. In this case, generating a steering profile (S410) may include generating the steering profile such that the steering reaction parameter is set for each driving situation.

As an example, the driving situation may be determined based on at least one of steering data, vehicle state data, and driving environment data included in the driving data. In this case, generating a steering profile (S410) may include determining the driving situation based on a vehicle state identifiable from the driving data, an environment around the vehicle, or the like.

Generating steering control information (S420) may include generating steering control information based on the steering profile and the steering input.

As an example, the steering control information may include road wheel steering control information regarding at what speed and to which position the road wheel is to be steered, feedback torque control information for assisting a steering input at the steering wheel or providing a reaction force, neutral restoring force control information regarding at what speed and with what intensity the steering wheel is to be restored to neutral if the steering input is stopped, and the like.

Controlling a steering device (S430) may include controlling the steering device according to the steering control information. For example, if there is a steering input of a driver, driver-customized steering control may be performed, such as controlling the road wheel to be steered to a specific position at a specific speed according to steering control information generated based on a steering profile reflecting the steering type and steering pattern of the corresponding driver, controlling the steering motor to generate a feedback torque corresponding to the steering input at the steering wheel, and controlling neutral restoration of the steering wheel to be performed at a specific speed and intensity if the steering input is stopped.

Meanwhile, the steering control method according to the present disclosure may control the steering device using the steering control information generated in generating steering control information as it is, but in some cases, if it is determined that steering correction is necessary, correction of the steering control information may be performed, and steering device control may be performed according to the corrected steering control information.

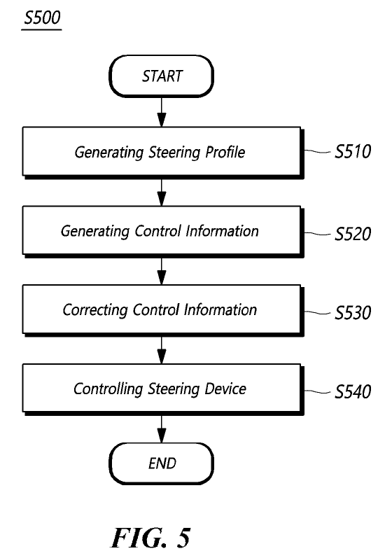

Considering this point, hereinafter, in FIG. 5, a steering control method including all the contents of the steering control method (S400) in FIG. 4 but further including correcting control information if it is determined that correction is necessary for the generated steering control information will be described.

FIG. 5 is a flowchart regarding a steering control method according to another embodiment.

Referring to FIG. 5, a steering control method (S500) according to another embodiment may include generating a steering profile (S510), generating steering control information (S520), correcting control information (S530), and controlling a steering device (S540).

In this case, generating a steering profile (S510) and generating steering control information (S520) may include all the contents described in generating a steering profile (S410) and generating steering control information (S420) in the steering control method (S400) described above in FIG. 4.

Correcting control information (S530), it is possible to determine whether correction of the steering control information is necessary, and correct the steering control information if it is determined that correction is necessary.

To this end, correction of the steering control information may be performed if a preset specific condition is satisfied, or correction of the steering control information may be performed based on a driving environment analysis such as a road state.

As an example, correcting control information (S530) may include determining steering intent of the driver by comparing the steering input of the driver with the steering pattern information of the driver, determining, based on the steering intent and a driving situation determined from the driving data, whether steering correction is to be performed, and correcting the steering control information in response to determining that steering correction is to be performed.

As an example, correcting control information (S530) may include determining steering intent as a normal steering intent in response to the steering input being within a normal steering range according to the steering pattern information, and determining whether the steering intent is a risk avoidance intent or a mistake based on the driving situation in response to the steering input being outside the normal steering range.

As an example, correcting control information (S530) may include determining that steering correction is to be performed in response to a correction threshold condition set according to the steering intent being satisfied.

As an example, correcting control information (S530) may include estimating road surface friction coefficient information by fusing road sensing data received from at least two or more sensors, and correcting the steering control information based on the road surface friction coefficient information.

As an example, correcting control information (S530) may include correcting the steering control information based on a relatively decreased steering sensitivity in response to the road surface friction coefficient information being less than a first threshold friction coefficient, and correcting the steering control information based on the decreased steering sensitivity while limiting steering behavior within a preset maximum steering behavior range in response to the road surface friction coefficient information being less than a second threshold friction coefficient which is less than the first threshold friction coefficient.

Controlling a steering device (S540) may include controlling the steering device according to the steering control information or the corrected steering control information. For example, steering control may be performed such that the road wheel is controlled to be steered to a specific position at a specific speed according to the generated steering control information as it is or according to the corrected steering control information if there is a steering input of the driver, the steering motor is controlled to generate a feedback torque corresponding to the steering input at the steering wheel, and neutral restoration of the steering wheel is controlled to be performed at a specific speed and intensity if the steering input is stopped.

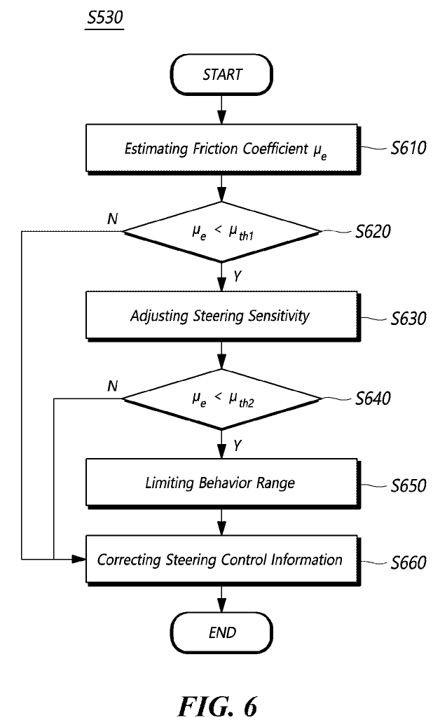

FIG. 6 is a flowchart for exemplarily describing correcting control information according to an embodiment.

Referring to FIG. 6, correcting control information (S530) according to an embodiment may include estimating a friction coefficient (S610), comparing with a first threshold friction coefficient (S620), adjusting steering sensitivity (S630), comparing with a second threshold friction coefficient (S640), limiting a behavior range (S650), and correcting the steering control information (S660).

Estimating a friction coefficient (S610) may include estimating a road surface friction coefficient(ex: μₑ) based on sensing data. In some cases, estimating a friction coefficient (S610) may include estimating road surface friction coefficient information by fusing road sensing data received from at least two or more sensors.

For example, estimating a friction coefficient (S610) may estimate the road surface friction coefficient more accurately by fusing sensing data of a road surface friction sensor inside a tire, a camera and a LiDAR mounted on a lower portion of the vehicle, and the like with data based on an AI-based road DB.

Comparing with a first threshold friction coefficient (S620) may include comparing the estimated road surface friction coefficient(ex: μₑ) with a first threshold friction coefficient(ex: μₜₕ₁). For example, if the estimated road surface friction coefficient is equal to or greater than the first threshold friction coefficient(ex: μₑ ≥ μₜₕ₁), it is determined that steering correction is not necessary and correcting control information (S530) is terminated, and if it is less than the first threshold friction coefficient(ex: μₑ < μₜₕ₁), it is determined that steering correction is necessary and adjusting steering sensitivity (S630) may proceed.

Adjusting steering sensitivity (S630), if it is determined that steering correction is necessary because the estimated friction coefficient is less than the first threshold friction coefficient, the steering sensitivity may be adjusted to be relatively decreased.

For example, if a steering profile is generated for a specific driver and steering control information is generated based on a steering sensitivity in such a steering profile, if it is determined in comparing with a first threshold friction coefficient (S620) that steering correction is necessary, the steering sensitivity in the steering profile may be relatively decreased. Then, in correcting the steering control information (S660) thereafter, the steering control information may be corrected in a manner of applying the decreased steering sensitivity to the steering input of the corresponding driver.

Comparing with a second threshold friction coefficient (S640) may include comparing the estimated road surface friction coefficient(ex: μₑ) with a second threshold friction coefficient(ex: μₜₕ₂). In this case, the second threshold friction coefficient may be set to a value less than the first threshold friction coefficient.

For example, if the estimated road surface friction coefficient is equal to or greater than the second threshold friction coefficient(ex: μₑ ≥ μₜₕ₂), it is determined that additional correction other than the correction in adjusting steering sensitivity (S630) is not necessary and correcting the steering control information (S660) proceeds immediately, and if it is less than the second threshold friction coefficient(ex: μₑ < μₜₕ₂), it is determined that additional steering correction is necessary and limiting a behavior range (S650) may proceed.

Limiting a behavior range (S650) may include setting a maximum steering behavior range if the estimated friction coefficient is less than the second threshold friction coefficient. Through this, the behavior range of the steering device is limited within a certain range, thereby reducing the risk of accidents and improving steering stability.

It may include correcting the steering control information based on the decreased steering sensitivity as much as possible but such that a preset maximum steering behavior range is not exceeded.

Correcting the steering control information (S660) may include performing correction of the steering control information based on each comparison result between the estimated road surface friction coefficient and the first threshold friction coefficient and the second threshold friction coefficient.

For example, if the estimated road surface friction coefficient is equal to or greater than the first threshold friction coefficient, it is determined that correction of the steering control information is not necessary, and correction of the steering control information may not be performed.

As another example, if the estimated road surface friction coefficient is less than the first threshold friction coefficient but equal to or greater than the second threshold friction coefficient, the steering control information may be corrected in a manner of applying the steering sensitivity relatively decreased in adjusting steering sensitivity (S630) instead of the steering sensitivity in the steering profile.

As another example, if the estimated road surface friction coefficient is less than the second threshold friction coefficient which is less than the first threshold friction coefficient, the steering control information may be corrected in a manner of applying the steering sensitivity relatively decreased in adjusting steering sensitivity (S630) instead of the steering sensitivity in the steering profile, but limiting such an application result so as not to exceed the maximum steering behavior range set in limiting a behavior range (S650).

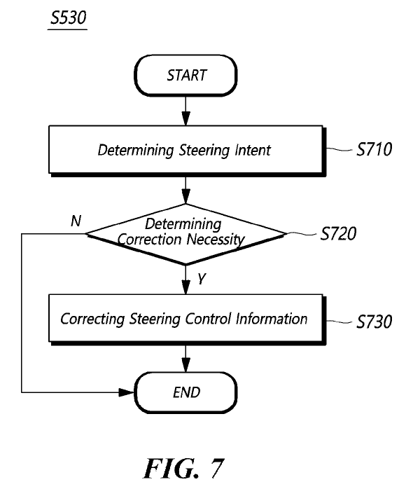

FIG. 7 is a flowchart for exemplarily describing correcting steering control information according to another embodiment.

Referring to FIG. 7, correcting control information (S530) according to another embodiment may include determining steering intent (S710), determining correction necessity (S720), and correcting steering control information (S730).

Determining steering intent (S710) may include comparing the steering input of the driver with the steering pattern information to determine steering intent of the driver. For example, if it is determined that the steering input of the driver is within a normal steering range on the steering pattern information appearing in the driving data of the corresponding driver, it may be determined as a normal steering intent, and if it is determined that the steering input is outside the normal steering range, it may be determined as not a normal steering intent, respectively.

Further, if it is determined that the steering input of the driver is not a normal steering intent, it is possible to determine whether the corresponding steering input is made with a risk avoidance intent or by mistake in consideration of the driving situation.

For example, if a rapid steering input deviating from the driver's existing driving pattern by a certain amount or more is made and it is determined that it is not a normal steering intent, if the driving situation was a situation where a front obstacle was detected or a sharp curve was required on road information, the steering intent may be determined as a risk avoidance intent, and unlike this, if there was a rapid steering input even though no special circumstances were seen in the driving situation, it may be determined as being caused by a mistake.

In determining correction necessity (S720), the steering intent of the driver and the driving state of the vehicle are compared, and if it is determined that driving according to the corresponding steering intent is not performed, it may be determined that correction of the steering control information is necessary.

Also, in some cases, in determining correction necessity (S720), if a correction threshold condition set differently according to the steering intent is satisfied, it may be determined that steering correction is necessary.

Then, if it is determined in determining correction necessity (S720) that steering correction is not necessary, correcting control information (S530) may be terminated, and if it is determined that steering correction is necessary, correcting steering control information (S730) may proceed.

correcting steering control information (S730) may include performing correction of the steering control information if it is determined in determining correction necessity (S720) that steering correction is necessary.

For example, correcting steering control information (S730) may correct steering control information regarding a subsequent road wheel steering angle to be a road wheel steering angle corresponding to the steering input and the steering intent if a difference between the road wheel steering angle corresponding to the steering input and steering intent of the driver and an angle at which the road wheel is actually steered is equal to or greater than a certain degree.

As another example, correcting steering control information (S730) may correct steering control information regarding a subsequent feedback torque to be a feedback torque corresponding to the steering input and the steering intent if a difference between the feedback torque corresponding to the steering input and steering intent of the driver and a feedback torque actually generated is equal to or greater than a certain degree.

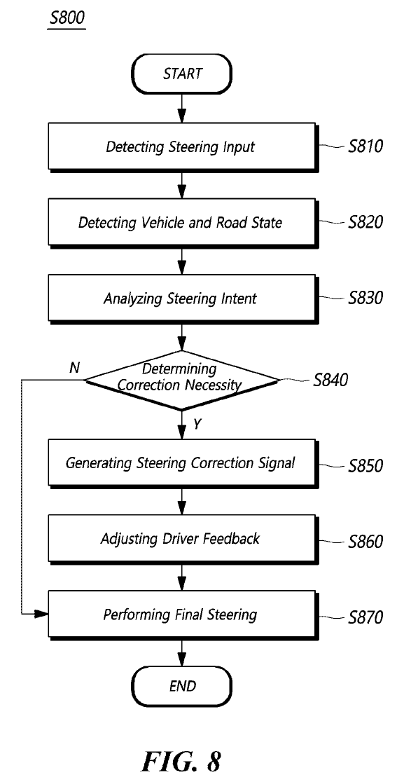

FIG. 8 is a flowchart regarding a steering control method according to yet another embodiment.

Referring to FIG. 8, a steering control method (S800) according to yet another embodiment may include detecting steering input (S810), detecting a vehicle and road state (S820), analyzing steering intent (S830), determining correction necessity (S840), generating a steering correction signal (S850), adjusting driver feedback (S860), and performing final steering (S870).

Detecting steering input (S810) may include detecting a steering input by a driver's handle manipulation. For example, data such as a rotation angle, a rotation speed, and a manipulation intensity of the handle may be collected from sensors such as a steering angle sensor and a steering torque sensor.

Detecting a vehicle and road state (S820) may include collecting and analyzing data regarding a vehicle state and a road state. For example, data regarding vehicle speed, driving acceleration, road slope, road surface friction coefficient, tire slip ratio, etc. may be collected using various sensors such as a vehicle speed sensor, an IMU, a road surface state sensor, a camera, a radar, and a LiDAR.

Analyzing steering intent (S830) may include analyzing steering intent of the driver by analyzing a direction and purpose in which the driver intends to steer, comparatively analyzing a steering speed and angle, and determining whether it is risk avoidance or a mistake if rapid steering is performed.

For example, analyzing steering intent (S830) may include analyzing the direction and purpose in which the driver actually intends to steer by recording the driver's steering pattern and comparing the existing steering pattern with a current steering input to determine whether it is sudden steering or normal steering.

Determining correction necessity (S840) may compare the driver's steering intent with the vehicle state to determine whether steering correction is necessary.

For example, if it is determined as normal steering as a result of comparing the steering intent and the vehicle state, in a case where the vehicle steers slowly while reversing at low speed, etc., performing final steering (S870) may proceed without steering correction.

As another example, if it is determined through driving data and steering intent analysis that the vehicle is slipping, or even if not, the road is slippery, if it is determined that the change in steering angle is rapid by a certain amount or more, or if the driver rotates the steering wheel rapidly during high-speed driving, it may be determined that steering correction is necessary.

Generating a steering correction signal (S850) may include generating a steering correction signal if it is determined that steering correction is necessary. For example, if it is determined that steering correction is necessary in a high-speed driving situation, a steering correction signal may be generated in a direction of relatively decreasing steering sensitivity, and if it is determined that steering correction is necessary in a low-speed driving situation, a steering correction signal may be generated in a direction of relatively increasing steering sensitivity.

Adjusting driver feedback (S860) may allow a relatively higher feedback torque to be generated in the steering motor if it is determined that steering correction is necessary, thereby preventing unnecessary steering from being performed.

Separately from this, in adjusting driver feedback (S860), if it is determined that steering correction is necessary, feedback informing the driver of the necessity of steering correction may be provided in a manner of causing vibration to be generated on the steering wheel to induce the driver's steering correction, or causing a warning system using a warning light, a warning sound, etc. to be activated.

Performing final steering (S870) may include performing steering finally by applying the initially generated steering signal if it is determined in determining correction necessity (S840) that correction is not necessary, and applying the steering correction signal to the road wheel if it is determined that correction is necessary. Through this, the steering actuator moves the road wheel, and the vehicle can be steered in the direction intended by the driver.

As described in the above contents, the present disclosure can provide a steering control device, method, and recording medium capable of performing steering control such that steering output and feedback in a steering device are performed in accordance with a driver and driving conditions.

Hereinafter, a recording medium on which a program for executing a steering control method capable of performing all the contents described above in the present disclosure is recorded and such a program stored in the recording medium will be described, and contents overlapping with those described above may be omitted in some cases, but may be all applied in terms of the recording medium and program below.

As an example, the steering control method according to the present disclosure may be implemented as a program and recorded on a computer-readable recording medium.

The steering control method described above may also be implemented in the form of a recording medium including instructions executable by a computer, such as an application or a program module executed by a computer. The computer-readable medium may be any available medium that can be accessed by a computer, and includes both volatile and non-volatile media, and removable and non-removable media. Further, the computer-readable medium may include all computer storage media. The computer storage medium includes both volatile and non-volatile, removable and non-removable media implemented by any method or technology for storage of information such as computer-readable instructions, data structures, program modules or other data.

The steering control method described above may be executed by an application basically installed in a terminal (which may include a program basically mounted on a platform or operating system mounted on the terminal), or may be executed by an application (i.e., a program) directly installed in a master terminal by a user through an application providing server such as an application store server, a web server related to the application or the corresponding service, or the like. In this sense, the steering control method described above may be implemented as an application (i.e., a program) basically installed in a terminal or directly installed by a user, and may be recorded on a computer-readable recording medium such as a terminal.

As an example, a non-transitory recording medium on which a program for executing the steering control method according to the present disclosure is recorded may have recorded thereon a program for executing a steering control method including: generating steering type information of a driver based on driving data of a vehicle using a steering type classification model, extracting steering pattern information of the driver from the driving data using a pattern extraction model, and generating a steering profile for the driver based on the steering type information and the steering pattern information; generating steering control information based on the steering profile of the driver and a steering input of the driver; and controlling a steering device according to the steering control information, and the program stored in such a non-transitory recording medium may be read through a computer.

As an example, the program recorded on the recording medium may be loaded in a computer, and may execute the functions described above by being installed and executed or by being executed without being installed.

As an example, the program recorded on the recording medium may include code coded based on a computer language such as C, C++, JAVA, Python, or machine language that can be read by a processor of a computer through a device interface of the computer so that the computer reads it and executes functions implemented as the program.

As an example, the code included in the program may include functional code related to a function defining the above-described functions, and may include control code related to an execution procedure necessary for the processor of the computer to execute the above-described functions according to a predetermined procedure.

Further, such code may further include memory reference related code as to at which location (address address) of the internal or external memory of the computer additional information or media necessary for the processor of the computer to execute the above-described functions should be referenced.

In addition, if communication with other computers or servers at a remote location is required for the processor of the computer to execute the above-described functions, the code may further include communication related code as to how the processor of the computer should communicate with any other computer or server at a remote location using the communication module of the computer, what information or media should be transmitted and received during communication, and the like.

The recording medium recording the program as described above includes, for example, a ROM, a RAM, a CD-ROM, a magnetic tape, a floppy disk, a USB, a hard disk, an optical media storage device, and the like, and may also include a case implemented in the form of a carrier wave (e.g., transmission through the Internet) and various storage servers.

Further, the recording medium storing the program according to the present disclosure may be connected to a network, and computing systems connected through such a network may be used to execute the program stored in the recording medium.

In some cases, computing systems connected through a network may share each other's computing resources, and a plurality of computing systems may access the program stored in the recording medium through the network at a time, and execute the program stored in the recording medium in a manner of distributing and allocating their respective computing resources.

In addition, the functional program for implementing the present disclosure and the code and code segment related thereto may be inferred or modified in part by programmers in the technical field to which the present disclosure belongs in consideration of the specifications or environment of the computing system that reads the recording medium and executes the program.

The subject matter and the operations described in this specification can be implemented in digital electronic circuitry or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial-access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The description in the present disclosure described above is for illustration, and those skilled in the art to which the present disclosure belongs will be able to understand that it can be easily modified into other specific forms without changing the technical idea or essential features of the present disclosure. Therefore, the embodiments described above should be understood as illustrative in all respects and not restrictive. For example, each component described as a single type may be implemented in a distributed manner, and similarly, components described as distributed may be implemented in a combined form.

The scope of the present disclosure is indicated by the claims to be described later rather than the detailed description above, and all changes or modified forms derived from the meaning and scope of the claims and their equivalent concepts should be interpreted as being included in the scope of the present disclosure.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A steering control device comprising:
at least one memory comprising computer program instructions; and
at least one processor configured to execute the computer program instructions,
wherein the at least one processor is configured to:
generate steering type information of a driver based on driving data of a vehicle using a steering type classification model;
extract steering pattern information of the driver from the driving data using a pattern extraction model;
generate a steering profile for the driver based on the steering type information and the steering pattern information; generate steering control information based of the steering profile of the driver and a steering input of the driver; and
control a steering device according to the steering control information.

2. The steering control device of claim 1, wherein the steering type classification model is configured to generate the steering type information of the driver by determining one of a plurality of steering types corresponding to each of a plurality of clusters generated through clustering of the driving data.

3. The steering control device of claim 1, wherein the pattern extraction model is configured to extract the steering pattern information by performing time-series analysis on a relationship between the steering input of the driver and the driving data.

4. The steering control device of claim 1, wherein the steering profile includes a steering reaction parameter for generating the steering control information by applying the steering reaction parameter to the steering input of the driver, and
wherein the at least one processor is configured to generate the steering profile such that the steering reaction parameter is set for each driving situation.

5. The steering control device of claim 4, wherein the driving situation is determined based on at least one of steering data, vehicle state data, and driving environment data included in the driving data.

6. The steering control device of claim 1, wherein the at least one processor is configured to:
determine a steering intent of the driver by comparing the steering input of the driver with the steering pattern information of the driver,
determine, based on the steering intent and a driving situation determined from the driving data, whether steering correction is to be performed, and
correct the steering control information in response to determining that steering correction is to be performed.

7. The steering control device of claim 6, wherein the at least one processor is configured to:
determine the steering intent as a normal steering intent in response to the steering input being within a normal steering range according to the steering pattern information, and
determine whether the steering intent is a risk avoidance intent or a mistake based on the driving situation in response to the steering input being outside the normal steering range.

8. The steering control device of claim 6, wherein the at least one processor is configured to determine that the steering correction is to be performed in response to a correction threshold condition set according to the steering intent being satisfied.

9. The steering control device of claim 6, wherein the at least one processor is further configured to:
estimate road surface friction coefficient information by fusing road sensing data received from at least two or more sensors, wherein correcting the steering control information is further based on the road surface friction coefficient information.

10. The steering control device of claim 9, wherein the at least one processor is configured to:
correct the steering control information based on a relatively decreased steering sensitivity in response to the road surface friction coefficient information being less than a first threshold friction coefficient, and
correct the steering control information based on the decreased steering sensitivity while limiting steering behavior within a preset maximum steering behavior range in response to the road surface friction coefficient information being less than a second threshold friction coefficient less than the first threshold friction coefficient.

11. A steering control method comprising:
generating steering type information of a driver based on driving data of a vehicle using a steering type classification model, extracting steering pattern information of the driver from the driving data using a pattern extraction model, and generating a steering profile for the driver based on the steering type information and the steering pattern information;
generating steering control information based on the steering profile of the driver and a steering input of the driver; and
controlling a steering device according to the steering control information.

12. The steering control method of claim 11, wherein the steering type classification model generates the steering type information of the driver by determining one of a plurality of steering types corresponding to each of a plurality of clusters generated through clustering of the driving data.

13. The steering control method of claim 11, wherein the pattern extraction model extracts the steering pattern information by performing time-series analysis on a relationship between the steering input of the driver and the driving data.

14. The steering control method of claim 11, wherein the steering profile includes a steering reaction parameter for generating the steering control information by applying the steering reaction parameter to the steering input of the driver, and
wherein generating the steering profile includes generating the steering profile such that the steering reaction parameter is set for each driving situation.

15. The steering control method of claim 14, wherein the driving situation is determined based on at least one of steering data, vehicle state data, and driving environment data included in the driving data.

16. The steering control method of claim 11, further comprising:
determining a steering intent of the driver by comparing the steering input of the driver with the steering pattern information of the driver,
determine, based on the steering intent and a driving situation determined from the driving data, whether steering correction is to be performed, and
correcting the steering control information in response to determining that steering correction is to be performed.

17. The steering control method of claim 16, wherein correcting the steering control information includes:
determining the steering intent as a normal steering intent in response to the steering input being within a normal steering range according to the steering pattern information, and determining whether the steering intent is a risk avoidance intent or a mistake based on the driving situation in response to the steering input being outside the normal steering range.

18. The steering control method of claim 16, wherein correcting the steering control information includes determining that the steering correction is to be performed in response to a correction threshold condition set according to the steering intent being satisfied.

19. The steering control method of claim 16, wherein correcting the steering control information comprising:
estimating road surface friction coefficient information by fusing road sensing data received from at least two or more sensors, wherein correcting the steering control information is further based on the road surface friction coefficient information.

20. A non-transitory computer-readable recording medium having recorded thereon a program for executing a steering control method, the method comprising:
generating steering type information of a driver based on driving data of a vehicle using a steering type classification model, extracting steering pattern information of the driver from the driving data using a pattern extraction model, and generating a steering profile for the driver based on the steering type information and the steering pattern information;
generating steering control information based on the steering profile of the driver and a steering input of the driver; and
controlling a steering device according to the steering control information.
